(19) United States
(12) Patent Application Publication
(10) Pub. No.: US 2007/0216625 A1
(43) Pub. Date: Sep. 20, 2007

(54) Switch matrices

(76) Inventors: Junko Masujima, Tokyo (JP); Hiroshi Nakamura, Tokyo (JP)

Correspondence Address: Paul D. Greeley;Ohlandt, Greeley, Ruggiero & Perle, L.L.P., One Landmark Square, 10th Floor, Stamford, CT, 06901-2682, US

(21) Appl. No.: 11/716,509

(22) Filed: Mar. 9, 2007

(30) Foreign Application Priority Data
Mar. 16, 2006 (JP) 2006-072074

(51) Int. Cl. G09G 3/36

(52) U.S. Cl. 345/89

(57) ABSTRACT

A switch matrix having a plurality of switch devices each of which has switch terminals is disclosed. An input side and an output side of the switch matrix are connected through the plurality of switch devices with coaxial cables. Two of the plurality of switch devices are disposed such that their terminal sides face each other. The rest of the plurality of switch devices are disposed in a vicinity of space between the terminal sides of the two switch devices, which face each other.

### BACKGROUND OF THE INVENTION

1. Field of the Invention

The present invention relates to switch matrices that switch a plurality of inputs and a plurality of outputs of high frequency signals.

2. Description of the Related Art

Various types of measurement instruments that measure high frequency parametric characteristics of semiconductor devices have been used. Switch matrices that switch desired terminals of a test elementary group of a semiconductor wafer and connect them to various types of measurement instruments have been used.

A switch matrix that has five single-pole-multi-throw (SPMT) switches disposed on each of two opposite planes is known (for example, refer to “NEW GENERATION OF SWITCH MATRICES BROADBAND DC-18 GHz SOLUTIONS”, Dow-Key Microwave Corporation (http://www.dowkey.com/products/DC-18Solutions.html)). In the switch matrix having such a structure, when the lengths of coaxial cables that connect terminals are minimized in each port, the lengths of coaxial cables fluctuate in each port. When coaxial cables having the same length are routed in each port, since the coaxial cables having the maximum length are used, the total cable length becomes large. As the length of the coaxial cables becomes large, the signal loss proportionally becomes large. When the insertion loss is minimized in each port, the insertion loss fluctuates in each port. When the insertion loss is equalized in each port, the total insertion loss becomes large. When the insertion loss becomes large, a measured signal attenuates, resulting in largely becoming susceptible to noise. In addition, as the length of the coaxial cable increases, a signal becomes susceptible to temperature changes.

As described above, it was difficult for the conventional switch matrices to equalize the insertion loss and influence due to temperature changes in each port and decrease the total insertion loss and influence due to temperature changes in the entire switch matrices.

### SUMMARY OF THE INVENTION

An object of the present invention is to solve the foregoing problems and provide switch matrices that allow the insertion loss and influence due to temperature changes to be equalized in each port and the total insertion loss and influence due to temperature changes in the entire switch matrices to be decreased.

To accomplish the foregoing object, the present invention is a switch matrix having a plurality of switch devices each of which has switch terminals. An input side and an output side of the switch matrix are connected through the plurality of switch devices with coaxial cables. Two of the plurality of switch devices are disposed such that their terminal sides face each other. The rest of the plurality of switch devices are disposed in a vicinity of space between the terminal sides of the two switch devices, which face each other. In this structure, the lengths of coaxial cables can be nearly equalized and the total length of coaxial cables can be decreased.

The two switch devices are disposed such that their terminal sides contact a virtual circle. At least a part of the rest of the plurality of switch devices is disposed such that its terminal side contacts the virtual circle.

At least a part of the rest of the plurality of switch devices is disposed such that its terminal side contacts a virtual circle whose center matches a center of a line which connects centers of the terminal sides of the two switch devices, which face each other. The virtual circle is placed on a plane perpendicular to the line.

The two switch devices are multi-contact switch devices having three or more selectable contacts each. The rest of the plurality of switch devices are two-contact switch devices having two selectable contacts each. The multi-point switch devices are single-pole-multiple-throw (SPMT_{[s1]}) switches, for example, SP6T switches having six selectable contacts each. The two-contact switches are single-pole-double-throw (SPDT) switches having two selectable contacts each.

The multi-contact switch devices are disposed on the input side. The two-contact switch devices are disposed on the output side.

The two-contact switch devices are collectively disposed at two positions. The two multi-contact switch devices on the input side and the two-contact switch devices at two positions are alternately disposed.

The switch matrix has two inputs and five outputs.

Two two-contact switch devices are also disposed at an upstream stage of the two multi-contact switch devices. The switch matrix has three or more inputs.

The present invention is a switch matrix having a plurality of switch devices each of which has switch terminals. An input side and an output side of the switch matrix are connected through the plurality of switch devices with coaxial cables. At least three of the plurality of switch devices are disposed such that their terminal sides contact a virtual circle.

The present invention is a switch matrix having a plurality of switch devices each of which has switch terminals. An input side and an output side of the switch matrix are connected through the plurality of switch devices with coaxial cables. At least three of the plurality of switch devices are disposed such that their terminal sides are placed on different sides of a virtual polyhedron. The polyhedron can be selected from many types for example a cubic, a rectangular parallelepiped, and a triangular pyramid. The switch devices may be high frequency type coaxial switches.

As described above, according to the present invention, the lengths of coaxial cables connected in each port switched with switch devices can be nearly equalized and the total length of the coaxial cables can be decreased.

Thus, as an effect of the present invention, the insertion loss and influence due to temperature changes of the switch matrix can be kept nearly in the same level in each port. In addition, the total insertion loss and influence due to temperature changes can be decreased.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a schematic diagram showing a structure of a switch matrix according to an embodiment of the present invention;

FIG. 2 is a perspective view showing an appearance of an SPDT switch;

FIG. 3 is a perspective view showing an appearance of an SP6T switch;

FIG. 4 is a perspective view showing an internal structure of a switch matrix;

FIG. 5 is a bottom view showing a structure of the switch matrix from which coaxial cables are removed;

FIG. 6 is a perspective view showing a mounting part of an SP6T switch;

FIG. 7 is a perspective view showing an appearance of a rack that accommodates four SPDT switches;

FIG. 8 is a perspective view showing an appearance of a rack that accommodates three SPDT switches;

FIG. 9 is a sectional view showing the switch matrix taken along line A-A of FIG. 5;

FIG. 10 is a sectional view showing the switch matrix taken along line B-B of FIG. 5;

FIG. 11 is a schematic diagram showing a structure of a switch matrix according to another embodiment of the present invention;

FIG. 12 is a schematic diagram showing a structure of a switch matrix according to another embodiment of the present invention;

FIG. 13 is a schematic diagram showing a structure of a switch matrix according to another embodiment of the present invention;

FIG. 14 is a schematic diagram showing a structure of a switch matrix according to another embodiment of the present invention; and

FIG. 15 is a schematic diagram showing a structure of a switch matrix according to another embodiment of the present invention.

### DESCRIPTION OF PREFERRED EMBODIMENTS

Next, with reference to the accompanying drawings, switch matrices according to embodiments of the present invention will be described.

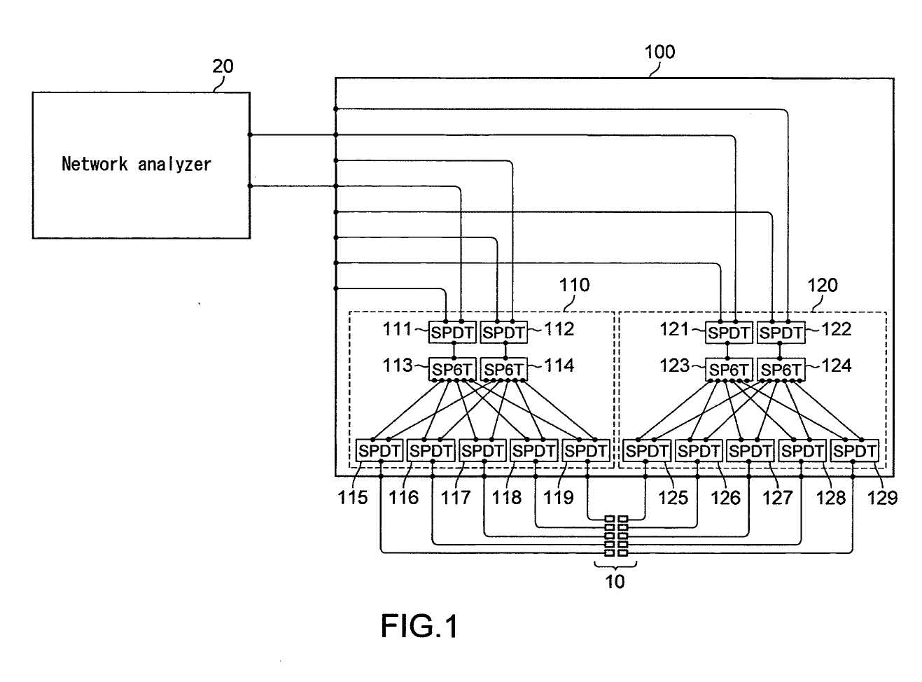

FIG. 1 is a schematic diagram showing a structure of a switch matrix according to an embodiment of the present invention. In FIG. 1, reference numeral 100 represents a test head. Disposed in the test head 100 are a source monitor unit (SMU) and so forth. In addition, a control unit that controls route selections of the switch matrix is also disposed in the test head 100. However, these units are omitted in FIG. 1. Reference numeral 10 represents pads formed in a TEG of a semiconductor wafer. Specifically, signal lines from the test head 100 contact the pads 10 with probers. Reference numeral 20 represents a network analyzer as an example of a measurement instrument, which measures semiconductor devices, used in the present invention. However, in the present invention, the measurement instrument, which is connected to the test head 100, is not limited to such an example. Instead, a pulse generator, an oscilloscope, an impedance meter, or another measurement instrument can be connected to the test head 100.

The test head 100 has switch matrices 110 and 120. In this patent application, it is assumed that one side of each of the switch matrices 110 and 120, connected to a measurement instrument such as the network analyzer 20, is referred to as the input side, whereas another side of each of the switch matrices 110 and 120, connected to the pads 10 on the semiconductor wafer, is referred to as the output side.

The switch matrix 110 has two single-pole-double-throw (SPDT) switches 111 and 112 on the input side. An SPDT switch is a switch that connects one selected input of two inputs to an output. In other words, an SPDT switch can control selection of one contact from two contacts. Outputs of the two SPDT switches 111 and 112 are connected to inputs of two single-pole-six-throw (SPST) switches 113 and 114 with coaxial cables, respectively. An SP6T switch is a switch that connects one input to one selected output of six outputs. In other words, an SP6T switch can control selection of one contact from six contacts.

In the switch matrices each of the SP6T switches 113 and 114 uses only five of six output terminals. Thus, instead of SP6T switches, single-pole-five-throw (SP5T) switches that connect one input to one selected output of five outputs may be used. In addition, the five outputs of the SP6T switch 113 are connected to one input of each of five SPDT switches 115, 116, 117, 118, and 119 disposed on the output side with coaxial cables. Likewise, the five outputs of the SP6T switch 114 are connected to another input of each of the SPDT switches 115, 116, 117, 118, and 119 with coaxial cables. Terminals on the input side of the test head 100 are connected to an input of each of the SPDT switches 111 and 112 with coaxial cables. In addition, outputs of the SPDT switches 115, 116, 117, 118, and 119 on the outside are connected to output terminals on the output side of the test head 100 with coaxial cables. These coaxial cables use an insulator made of Teflon, which is not largely affected by temperature changes (Teflon is a registered trademark of du Pont). Instead, another type of coaxial cables such as semi-rigid cables may be used.

Since the structure of the switch matrix 120 is the same as that of the switch matrix 110, for simplicity, the description of the structure of the switch matrix 120 will be omitted.

With the SP6T switches 113 and 114, SPDT switches 115, 116, 117, 118, and 119, and their connection coaxial cables, a two-input-five-output switch matrix can be structured.

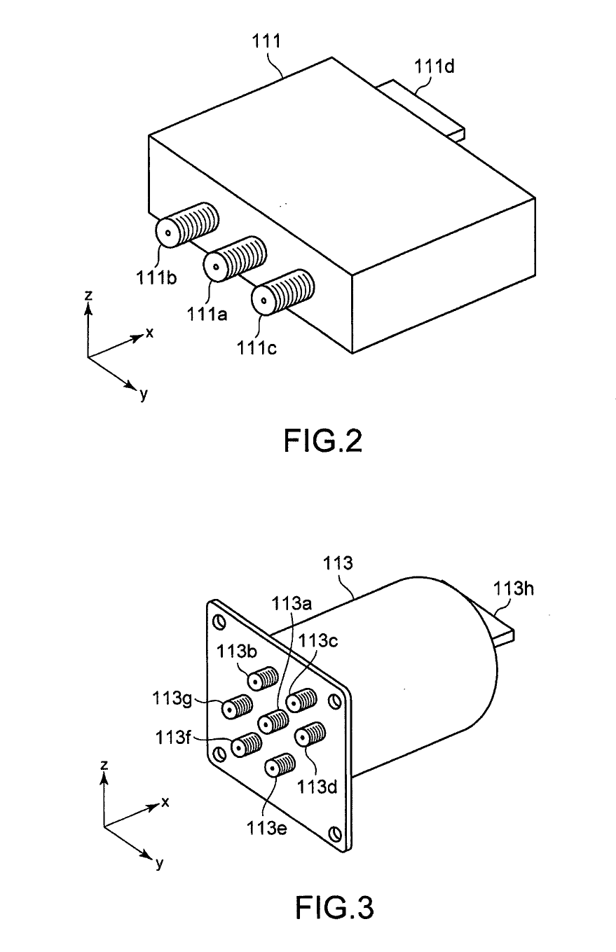

FIG. 2 is a perspective view showing an appearance of the SPDT switch 111. As shown in FIG. 2, the SPDT switch 111 has a rectangular parallelepiped housing. Disposed on one side of the housing are coaxial terminals 111a, 111b, and 111c that are aligned in line. Disposed on the opposite side of the terminal side is a control signal terminal 111d with which connections of these terminals are controlled. With a signal supplied from the control signal terminal 111d, electrical connections of the terminal 111a to the terminal 111b and the terminal 111c are controlled. In this embodiment, the distance between the center of the coaxial terminal 111a and the center of each of the coaxial terminal 111b and the coaxial terminal 111c, which are aligned in line, is 11 mm. The coaxial terminals 111a, 111b, and 111c are coaxial connectors. In addition, the SPDT switch 111 is a high frequency type coaxial switch.

FIG. 3 is a perspective view showing an appearance of the SP6T switch 113. As shown in FIG. 3, the SP6T switch 113 has a cylindrical housing. Disposed on one end of the housing are coaxial terminals 113a, 113b, 113c, 113d, 113e, 113f, and 113g. The coaxial terminals 113b, 113c, 113d, 113e, 113f, and 113g are disposed at apex positions of a regular hexagon with a center of the coaxial terminal 113a. Disposed on the opposite side of the terminal side is a control signal terminal 113h with which connections of the coaxial terminals 113a, 113b, 113c, 113d, 113e, 113f, and 113g are controlled. With a signal supplied from the control signal terminal 113h, electric connections of the coaxial terminal 113a to the coaxial terminals 113b, 113c, 113d, 113e, 113f, and 113g are controlled. In this embodiment, the distance between the center of the coaxial terminal 113g and the center of the coaxial terminal 113d is 26.97 mm. The coaxial terminals 113a to 111g are coaxial connectors. The SP6T switch 113 is a high frequency type coaxial switch.

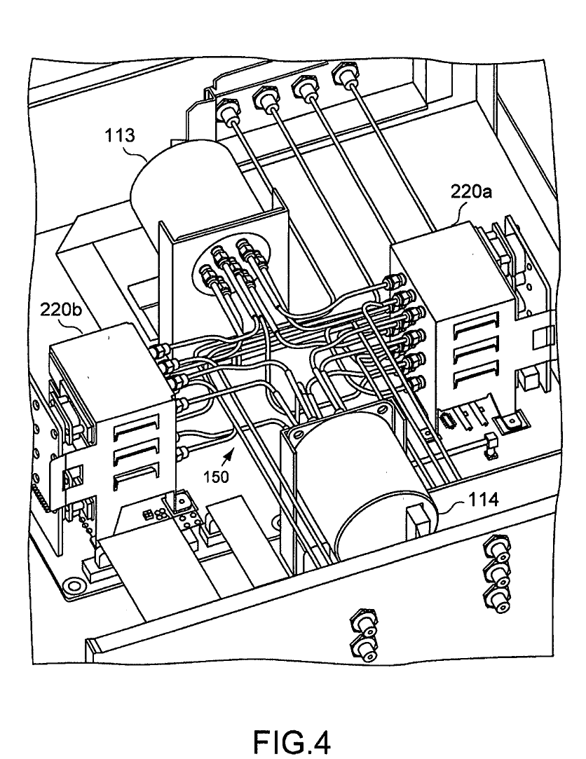

FIG. 4 is a perspective view showing an internal structure of the switch matrix 110. As shown in FIG. 4, the SP6T switches 113 and 114 are disposed such that they face each other. Seven SPDT switches are accommodated in the racks 220a and 220b such that four SPDT switches are accommodated in the rack 220a and three SPDT switches are accommodated in the rack 220b. The terminal side of each of the SPDT switches accommodated in the rack 220a faces the terminal side of each of the SPDT switches accommodated in the rack 220b. The coaxial terminals of the SP6T switches 113 and 114 and the coaxial terminals of the SPDT switches are connected with coaxial cables 150.

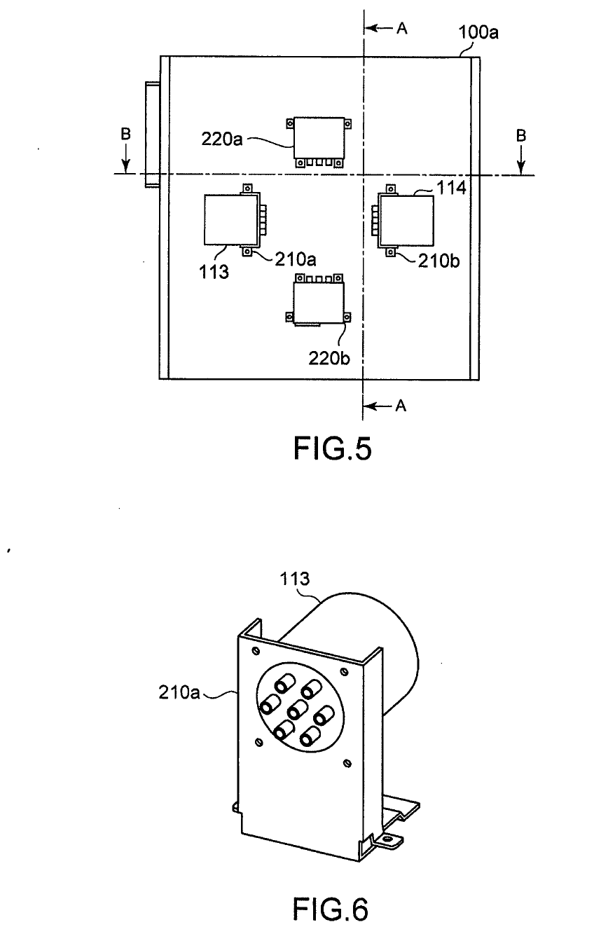

FIG. 5 is a bottom view showing a structure of the switch matrix 110 from which coaxial cables are removed. As shown in FIG. 5, the SP6T switches 113 and 114 are disposed such that their terminal side faces each other. The racks 220a and 220b are disposed such that the terminal side of each of the SPDT switches accommodated in the rack 220a face the terminal side of each of the SPDT switches accommodated in the rack 220b. In this embodiment, the distance between the terminal side of the SP6T switch 113 and the terminal side of the SP6T switch 114 is 138 mm. The distance between the terminal side of each of the SPDT switches accommodated in the rack 220a and the terminal side of each of the SPDT switches accommodated in the rack 220b is 142 mm. The SP6T switch 113 and the SP6T switch 114 are mounted on a housing 100a of the test head 100 with mounting members 210a and 210b, respectively. In other words, the racks 220a and 220b are mounted in the vicinity of the space between the terminal side of the SP6T switch 113 and the terminal side of the SP6T switch 114.

FIG. 6 is a perspective view showing the mounting member 210a of the SP6T switch 113. As shown in FIG. 6, the mounting member 210a has a circular opening at which the six coaxial terminals of the SP6T switch 113 are disposed.

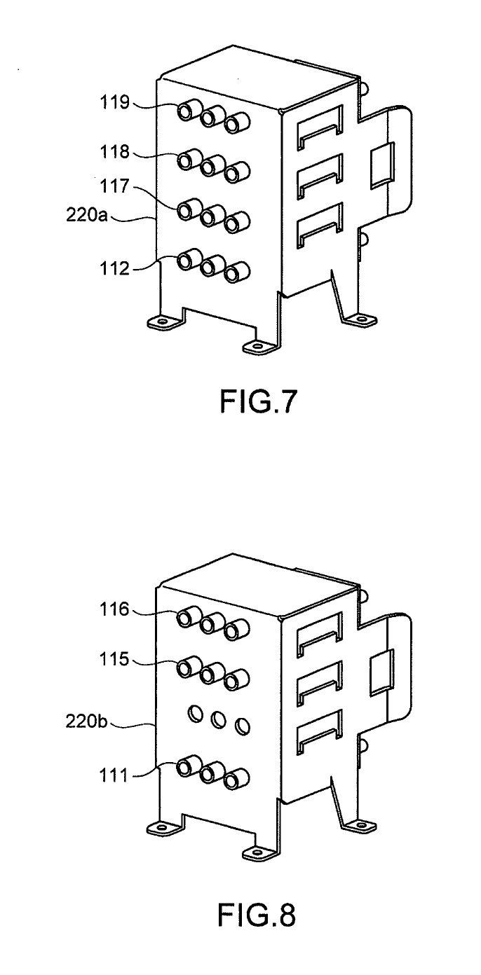

FIG. 7 is a perspective view showing an appearance of the rack 220a. As shown in FIG. 7, the rack 220a accommodates the four SPDT switches 112, 117, 118, and 119 successively placed from the bottom.

FIG. 8 is a perspective view showing an appearance of the rack 220b. As shown in FIG. 8, the rack 220b does not accommodate an SPDT switch at the second position viewed from the bottom. The rack 220b accommodates the SPDT switches 111, 115, and 116 at the first, third, and fourth positions viewed from the bottom.

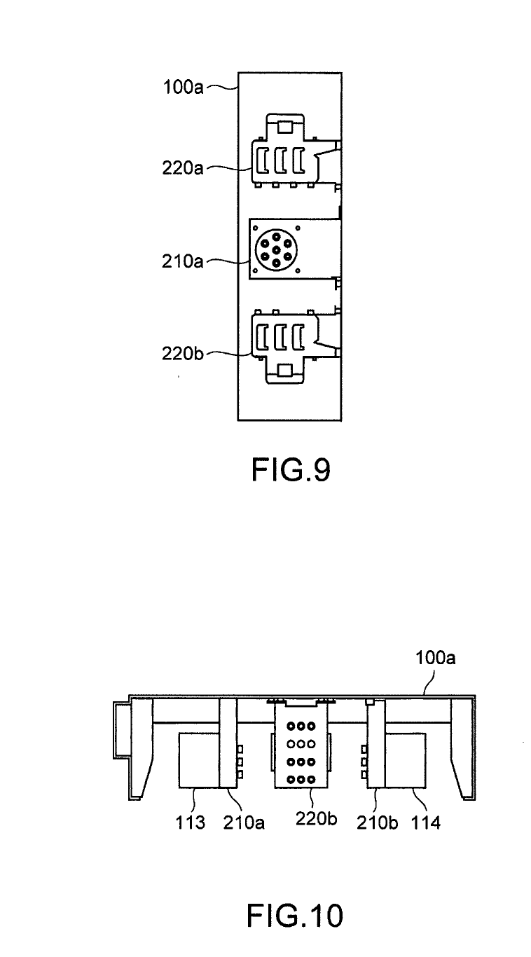

FIG. 9 is a sectional view showing the switch matrix 110 taken along line A-A of FIG. 5. As shown in FIG. 9, the terminal side of each of the SPDT switches accommodated in the rack 220a faces the terminal side of each of the SPDT switches of the rack 220b. In this embodiment, the distance between the center of the center coaxial terminal of the SP6T switch 113 mounted on the mounting member 210a and the component mounting side of the housing 110a is 707.5 mm.

FIG. 10 is a sectional view showing the switch matrix 110 taken along line B-B of FIG. 5. As shown in FIG. 10, the SP6T switch 113 and the SP6T switch 114 are mounted on the housing 100a with the mounting members 210a and 210b such that the terminal side of the SP6T switch 113 faces the terminal side of the SP6T switch 114. In this embodiment, the distance between the centers of vertically adjacent coaxial terminals of adjacent SPDT switches accommodated in each of the racks 220a and 220b is 18.7 mm. The distance between the housing 10a and the center of each of the coaxial terminals of the SPDT switch 111 disposed at a position closest to the housing 10a is 33.35 mm.

As shown in FIG. 4, the coaxial terminals were connected with coaxial cables in the structure shown in FIG. 1 in the conditions shown in FIG. 2 to FIG. 10. The cable lengths of coaxial cables from the SP6T switches 113 and 114 to the SPDT switches 115 to 119 on the output side most affect the total insertion loss, and insertion loss and influence due to temperature changes in each port. In this embodiment, these lengths were 120 mm±10 mm.

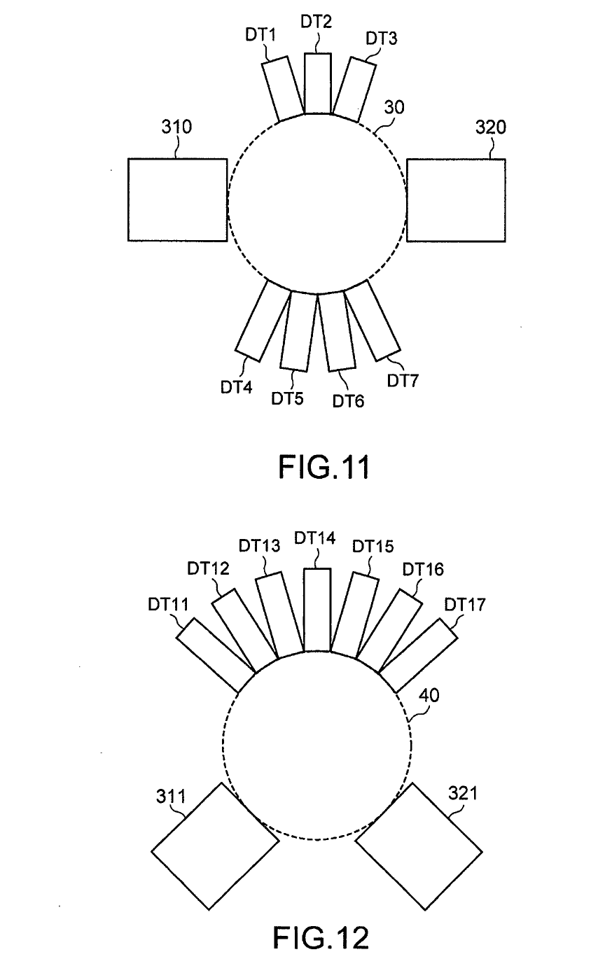

FIG. 11 schematically shows a structure of a switch matrix according to another embodiment of the present invention. In FIG. 11, reference numerals 310 and 320 represent SP6T switches, whereas DT1, DT2, DT3, DT4, DT5, DT6, and DT7 represent SPDT switches. As shown in FIG. 11, the SP6T switches 310 and 320 are disposed such that their terminal sides contact a virtual circle and face each other. The switches DT1, DT2, and DT3 are disposed such that they are adjacently aligned around the circle 30 and their terminal sides contact the circle 30. Likewise, the switches DT4, DT5, DT6, and DT7 are disposed such that they are adjacently aligned around the circle 30 and their terminal sides contact the circle 30.

Since the distance between any point on the circle 30 and the center thereof is constant, when the coaxial terminals are connected with coaxial cables in this structure, the lengths of the coaxial cables that connect the coaxial terminals nearly become equal. To shorten the lengths of the coaxial cables, it is necessary to satisfy the relationship of the positions of the switches such that the diameter of the virtual circle 30 decreases.

FIG. 12 is a schematic diagram showing a structure of a switch matrix according to another embodiment of the present invention. In FIG. 12, reference numerals 311 and 321 represent SP6T switches, whereas DT11, DT12, DT13, DT14, DT15, DT16, and DT17 represent SPDT switches. As shown in FIG. 12, the SP6T switches 311 and 321 are disposed such that their terminal sides contact a virtual circle 40. The switches DT11, DT12, DT13, DT14, DT15, DT16, and DT17 are disposed such that they are adjacently aligned around the virtual circle 40 and their terminal sides contact the virtual circle 40. When the coaxial terminals are connected with coaxial cables in this structure, the lengths of the coaxial cables that connect the coaxial terminals nearly become equal. To shorten the lengths of the coaxial cables, it is necessary to satisfy the relationship of the positions of the switches such that the diameter of the virtual circle 40 decreases.

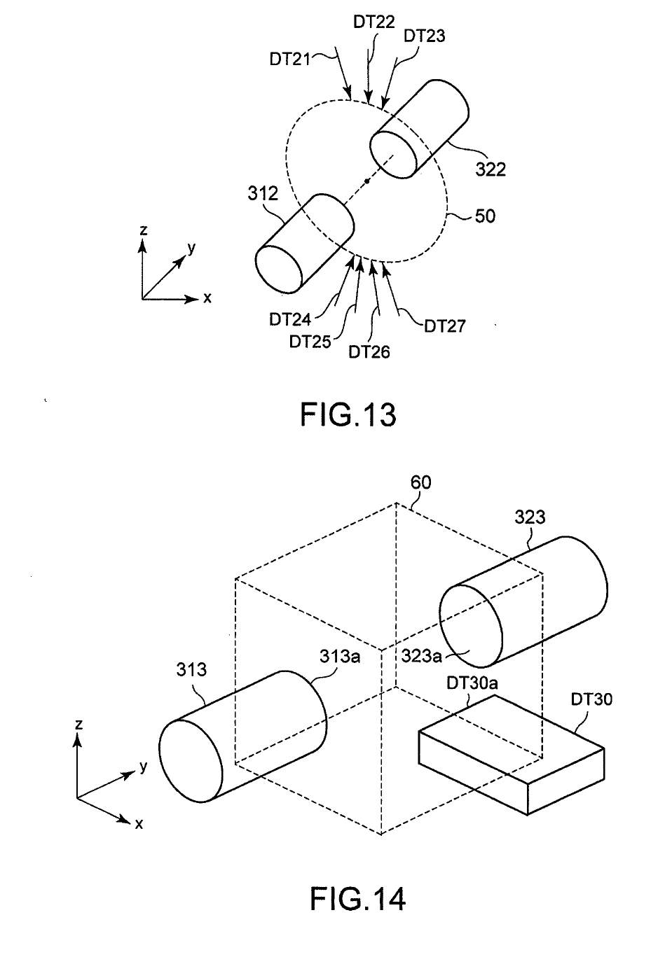

FIG. 13 is a schematic diagram showing a structure of a switch matrix according to another embodiment of the present invention. In FIG. 13, reference numerals 312 and 322 represent SP6T switches that are disposed such that their terminal sides face each other, whereas arrows DT21, DT22, DT23, DT24, DT25, DT26, and DT27 represent orientations and positions of terminal sides of SPDT switches. In other words, the direction of each arrow represents the normal direction of the terminal side. The tip of each of the arrows represents the position of a point of contact of the terminal side and a virtual circle 50. As shown in FIG. 13, the SP6T switches 312 and 322 are disposed such that their terminal sides face each other. In addition, as represented by DT21, DT22, and DT23, the SPDT switches are disposed such that they are adjacently aligned around the virtual circle 50 and their terminal sides contact the virtual circle 50 whose center matches the center of a line that connects the SP6T switches 312 and 322, the virtual circle 50 being placed on a plane perpendicular to the line. In addition, as represented by DT24, DT25, DT26, and DT27, the SPDT switches are disposed such that SPDT switches are adjacently aligned around the virtual circle 50 and their terminal sides contact the virtual circle 50. When the coaxial terminals are connected with coaxial cables in this structure, the lengths of the coaxial cables that connect the coaxial terminals nearly become equal. To shorten the lengths of the coaxial cables, it is necessary to satisfy the relationship of the positions of the switches such that the diameter of the virtual circle 50 decreases.

FIG. 14 is a schematic diagram showing a structure of a switch matrix according to another embodiment of the present invention. As shown in FIG. 14, in the switch matrix according to this embodiment, SP6T switches 313 and 323 are disposed such that their terminal sides 313a and 323a are placed on two opposite sides of a virtual cubic 60 as an example of a polyhedron. In addition, an SPDT switch DT30 is disposed such that its terminal side DT30a is placed on another side of the cubic 60.

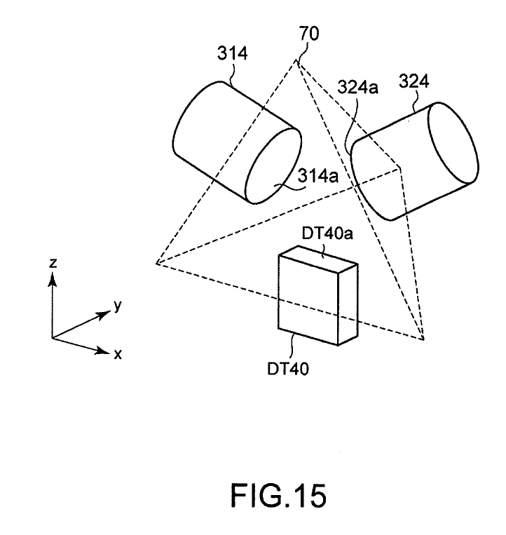

FIG. 15 is a schematic diagram showing a structure of a switch matrix according to another embodiment of the present invention. As shown in FIG. 15, SP6T switches 314 and 324 are disposed such that their terminal sides 314a and 324a are placed on two sides of a virtual triangular pyramid 70 as an example of a polyhedron. In addition, an SPDT switch 40 is disposed such that its terminal side DT40a is placed on another surface of the virtual triangular pyramid 70.

In FIG. 14 and FIG. 15, a switch matrix is applied to a cubic and a triangular pyramid. Instead, a switch matrix may be applied to another polyhedron.

In the embodiments shown in FIG. 11 to FIG. 15, only the relationships of the positions of the switches are represented. Specifically, fixing members that fix the switches and coaxial cables that connect coaxial terminals are disposed.

As described above, with the switch matrices according to embodiments of the present invention, while the lengths of coaxial cables that connect SP6T switches and SPDT switches on the output side are kept constant, the total length of the coaxial cables can be decreased. Thus, the insertion loss and influence due to temperature changes are nearly the same in each port. In addition, the total insertion loss and influence due to temperature changes can be decreased.

Although the present invention has been shown and described with respect to best mode embodiments thereof, it should be understood by those skilled in the art that the foregoing and various other changes, omissions, and additions in the form and detail thereof may be made therein without departing from the spirit and scope of the present invention.

What is claimed is:

1. A switch matrix, comprising:
a plurality of switch devices each of which has switch terminals, an input side and an output side of the switch matrix being connected through the plurality of switch devices with coaxial cables,
wherein two of the plurality of switch devices are disposed such that their terminal sides face each other, and
wherein the rest of the plurality of switch devices are disposed in a vicinity of space between the terminal sides of the two switch devices, which face each other.

2. The switch matrix as set forth in claim 1,
wherein the two switch devices are disposed such their terminal sides contact a virtual circle, and
wherein at least a part of the rest of the plurality of switch devices is disposed such that its terminal side contacts the virtual circle.

3. The switch matrix as set forth in claim 1,
wherein at least a part of the rest of the plurality of switch devices is disposed such that its terminal side contacts a virtual circle whose center matches a center of a line which connects centers of the terminal sides of the two switch devices, which face each other, the virtual circle being placed on a plane perpendicular to the line.

4. The switch matrix as set forth in claim 1,
wherein the two switch devices are multi-contact switch devices having three or more selectable contacts each, and
wherein the rest of the plurality of switch devices are two-contact switch devices having two selectable contacts each.

5. The switch matrix as set forth in claim 4,
wherein the multi-contact switch devices are disposed on the input side, and
wherein the two-contact switch devices are disposed on the output side.

6. The switch matrix as set forth in claim 5,
wherein the two-contact switch devices are collectively disposed at two positions, and
wherein the two multi-contact switch devices on the input side and the two-contact switch devices at two positions are alternately disposed.

7. The switch matrix as set forth in claim 1,
wherein the switch matrix has two inputs and five outputs.

8. The switch matrix as set forth in claim 4, further comprising:
two-contact switch devices disposed at an upstream stage of the two multi-contact switch devices,
wherein the switch matrix has three or more inputs.

9. A switch matrix, comprising:
a plurality of switch devices each of which has switch terminals, an input side and an output side of the switch matrix being connected through the plurality of switch devices with coaxial cables,
wherein at least three of the plurality of switch devices are disposed such that their terminal sides contact a virtual circle.

10. A switch matrix, comprising:
a plurality of switch devices each of which has switch terminals, an input side and an output side of the switch matrix being connected through the plurality of switch devices with coaxial cables,
wherein at least three of the plurality of switch devices are disposed such that their terminal sides are placed on different sides of a virtual polyhedron.

11. The switch matrix as set forth in claim 1,
wherein the switch devices are high frequency type coaxial switches.
